(19) United States
(12) Patent Application Publication
(10) Pub. No.: US 2004/0166835 A1
(43) Pub. Date: Aug. 26, 2004

(54) Radio resource management with adaptive congestion control

(76) Inventors: Klas Johansson, Sundbyberg (SE); Christian Braun, Malmo (SE); Martin Kristensson, Helsinki (FI); David Soldani, Espoo (FI); Pekka Tapani Kohonen, Espoo (FI); Albert Hoglund, Helsinki (FI); Benoist Guillard, Paris (FR)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/603,079

(22) Filed: Jun. 25, 2003

Related U.S. Application Data
(60) Provisional application No. 60/448,097, filed on Feb. 20, 2003.

(51) Int. Cl. H04Q 7/20

(52) U.S. Cl. 455/414.1; 455/403

(57) ABSTRACT

This invention concerns a method for controlling at least one radio bearer parameter of a first radio bearer (RB), and a Radio Bearer Control unit. The invention introduces a continuous monitoring and controlling of the RAB-RB parameter mapping for new and for already active connections. According to the invention a method for controlling at least one radio bearer parameter of a first radio bearer (RB) to be established or maintained between a mobile terminal and a first access-network node in a first cell of a cellular radio access network is provided. The first access-network node communicates with a core-network node in a core network to establish or maintain at least one radio access bearer (RAB) between the mobile terminal and the core-network node. The method of the invention comprises the steps of ascertaining a current value of at least one load parameter indicative of an air interface load of said first cell, ascertaining a current first target or limit value of at least one, radio access bearer parameter of said radio access bearer, and selecting a second target or limit value of said radio bearer parameter in dependence on said first target or limit value and said current value of said load parameter. During the setup of the radio bearer the method of the present method allows to select target or limit values for the radio bearer to be established that correspond to the targets or limits set by the radio access bearer parameters. The method of the invention is also applicable at any point during a time span that a radio bearer is established. It may thus be used for tuning the radio bearer in response to changing loads or radio access bearer parameters.

### REFERENCE TO RELATED APPLICATIONS

This application claims priority of U.S. Provisional Patent Application No. 60/448,097, filed on Feb. 20, 2003. The contents of this provisional patent application is hereby incorporated by reference.

### BACKGROUND OF THE INVENTION

1. Field of the Invention

This invention is in the field of Radio Resource Management (RRM). It concerns a method for controlling at least one Radio Bearer parameter of a first Radio Bearer (RB), and a Radio Bearer Control unit. It also concerns an Admission Control unit, and a Radio Network Controller.

2. Description of the Related Art

Radio Resource Management (RRM) algorithms are designed to fulfill predetermined quality of service (QoS) requirements for individual connections while still maximizing the total system throughput under high load conditions.

With the introduction of a broad range of services and with the introduction of classes providing different QoS in mobile communication systems, differentiating the service offerings to the customers is of increasing importance to the operators.

In UMTS, four QoS classes are defined: conversational class, streaming class, interactive class, and background class. The main distinguishing factor between these QoS classes is the sensitivity to a delay in the traffic. The conversational class is meant for traffic which is very delay sensitive, meaning that low delay is more important than lossless transmission, while the background class is the most delay insensitive traffic class, where lossless transmission is more important than low delay.

The conversational and streaming classes are mainly intended to be used to carry real-time traffic flows. Interactive class and Background are mainly meant to be used by traditional Internet applications like World Wide Web (WWW), E-mail, Telnet, FTP and News. Due to looser delay requirements, compared to conversational and streaming classes, both provide better error rate by means of channel coding and retransmission.

The Radio Resource Management function comprises Power Control (PC), Handover Control (HC), Congestion Control, and a Resource Manager (RM).

The present invention deals with Congestion Control. Congestion Control is typically subdivided into Admission Control (AC), Load Control (LC) and Packet Scheduling (PS). Admission Control, together with Load Control and Packet Scheduling, ensures that the network stays within the planned condition. Load control manages situations when system load has exceeded given thresholds and some countermeasures have to be taken to get the system back to a feasible load. Packet Scheduling handles all non-real-time (NRT) traffic. It decides when a packet transmission is initiated and the bit rate to be used.

AC maintains information about all available resources of a network entity and about all resources allocated to UMTS bearer services. It determines for each UMTS bearer service request or modification whether the required resources can be provided by this entity and it reserves these resources if allocated to the UMTS bearer service. The function checks also the capability of the network entity to provide the requested service, i.e. whether the specific service is implemented and not blocked for administrative reasons. The resource control performed by the Admission Control supports also the service retention. AC lets users set up or reconfigure a RAB only if these would not overload the system and if the necessary resources are available.

Admission Control (AC) performs the functionality of mapping Radio Access Bearer (RAB) parameters onto Radio Bearer (RB) parameters at the setup of a connection, or when the RAB parameters are re-negotiated. That is, RB parameters are decided from Radio Access Bearer (RAB) parameters of the desired service.

A bearer is a logical connection with specific capabilities offering a set of services, called bearer services, between the end points of the bearer. In the Universal Mobile Telecommunications System (UMTS), a UMTS bearer service comprises a Radio Access Bearer (RAB) service and a core network (CN) Bearer service.

The Radio Access Bearer (RAB) Service provides transport of signalling and user data between a mobile terminal (MT), also called user equipment (UE) hereinafter, and a core network (CN) Iu Edge Node. The RAB parameters decide the QoS between the Core Network and the User-Equipment in the UMTS architecture. The CN Bearer Service provides transport of signalling and user data between the Iu Edge Node and a CN Gateway.

A RAB service consists of a Radio Bearer (RB) service and an Iu Bearer service. A RB is a bearer provided between a mobile terminal (MT) and a Radio Access Network (RAN), that is, in UMTS, a UTRAN (Universal Terrestrial RAN) or a GERAN (GSM Edge RAN). The role of the Radio Bearer Service is to cover all the aspects of the radio interface transport. Radio Bearer (RB) parameters decide the QoS for a radio connection. The Iu-Bearer Service provides the transport between the UTRAN and the CN.

Most RB parameters that define a service within the radio access network are fixed after setup of a RAB. The quality of service parameters are set at the RAB setup and kept for the rest of the session. The only variable parameter is the bit rate for non-real-time (NRT) services, which is controlled in high-load situations.

This means that services with low priority are maintained even in overload situations, preventing higher prioritized users to enter. However, in extreme overload cases, low priority users may be forced to handover or drop the connection. Therefore, the current solution is a blunt instrument when it comes to trade capacity vs. quality in a radio access network.

The problem is today solved only in part by experimentation on testbed or experimental networks. An optimization is done by a manual change of parameters. The resulting set of parameters is applied to the whole RAN system, independently of the cell- and user specific radio environment.

### SUMMARY OF THE INVENTION

In one embodiment, the invention is directed to a method for controlling at least one radio bearer parameter of a first radio bearer to be established or maintained between a mobile terminal and a first access-network node in a first cell of a cellular radio access network. The method includes determining a currently value of at least one load parameter indicative of an air interface load of a first cell. A current first target or limit value of at least one radio access bearer parameter of a radio access bearer is determined, then a second target value or a limit value of the radio bearer parameter is selected based upon the first target or limit value and the current value of the load parameter. The first access-network node communicates with a core-network node in a core network to establish or maintain at least one radio access bearer between the mobile terminal and the core-network node.

The invention also includes in another embodiment, a radio bearer control unit for controlling at least one radio bearer parameter. The unit includes a Parameter Retrieval unit configured to communicate with an external admission control unit for ascertaining a current first target or limit value of at least one radio access bearer parameter. A Performance Data Retrieval unit is adapted to communicate with an external radio network monitoring statistics unit, and receives at least one current measured value of at least one air interface load parameter. A Radio Bearer Parameter Control unit communicates with the parameter retrieval unit and the performance data retrieval unit, and is configured to select a second target or limit value of a radio bearer parameter based upon the first target or limit value and the current value of the at least one air interface load parameter.

The invention also includes in another embodiment, a system for controlling at least one radio bearer parameter of a first radio bearer to be established or maintained between a mobile terminal and a first access-network node in a first cell of a cellular radio access network. The system includes first determining means for determining a current value of at least one load parameter indicative of an air interface load of a first cell, and second determining means for determining a current first target or limit value of at least one radio access bearer parameter of a radio access bearer. Selecting means are provided, for selecting a second target value or limit value of the radio bearer parameter based upon the first target or limit value and the current value of the load parameter. The first access-network node communicates with a core-network node in a core network to establish or maintain the at least one radio access bearer between the mobile terminal and the core-network node.

Another embodiment of the invention includes a radio bearer control unit for controlling at least one radio bearer parameter. The radio bearer control unit includes parameter retrieval means for communicating with an external admission control unit for ascertaining a current first target or limit value of at least one radio access bearer parameter, performance data retrieval means for communicating with an external radio network monitoring statistics unit for receiving at least one current measured value of at least one air interface load parameter, and radio bearer parameter control means communicating with the parameter retrieval means and the performance data retrieval means. The radio bearer parameter control means selects a second target or limit value of a radio bearer parameter based upon the first target or limit value and the current value of the at least one air interface load parameter.

### BRIEF DESCRIPTION OF THE DRAWINGS

For complete understanding of the invention, reference should be made to the following description and the accompanying drawings, wherein:

FIG. 1 shows a simplified network structure of a radio access network with a preferred embodiment of a radio network controller of the invention;

FIG. 2 shows a flow diagram of a first preferred embodiment of the RB parameter control method of the invention;

FIG. 3 shows a flow diagram of a second preferred embodiment of the RB parameter control method of the invention;

FIG. 4 shows an example of a QoS indicator table used as an input to the mapping between RAB and RB parameters;

FIG. 5 shows a diagram depicting the dependence of the perceived QoS as a function of the cell load according to the method of the invention;

FIG. 6 shows a diagram depicting schematically the data channel throughput as a function of the target frame error rate; and

FIG. 7 shows a diagram depicting a cost function as a function of block error rate for different moving velocities of a mobile terminal.

### DESCRIPTION OF THE PREFERRED EMBODIMENTS

According to a first aspect of the invention a method for controlling at least one radio bearer parameter of a first radio bearer (RB) to be established or maintained between a mobile terminal and a first access-network node in a first cell of a cellular radio access network is provided. The first access-network node communicates with a core-network node in a core network to establish or maintain at least one radio access bearer (RAB) between the mobile terminal and the core-network node. The method of the invention comprises the steps of

ascertaining a current value of at least one load parameter indicative of an air interface load of said first cell

ascertaining a current first target or limit value of at least one radio access bearer (RAB) parameter of said radio access bearer

selecting a second target or limit value of said radio bearer parameter in dependence on said first target or limit value and said current value of said load parameter.

The method of the invention is applicable in the process of establishing a radio bearer. When the quality of service is negotiated during the setup of the radio bearer the method of the present invention allows to select target or limit values for the radio bearer to be established that correspond to the targets or limits set by the radio access bearer parameters and to the current air interface load of the cell. The method of the invention is also applicable at any point during a time span that a radio bearer is established. It may thus be used for tuning the radio bearer in response to changing loads or radio access bearer parameters. This invention therefore enables a continuous monitoring and controlling of the RAB-RB parameter mapping for new and for already active connections.

In order to be able to adapt to a current load situation in the cell in which the radio bearer is active or shall be established—this cell is called the first cell in this context—, the method of the invention comprises a step of ascertaining a current value of at least one load parameter indicative of an air interface load of said first cell. The air interface load can be measured by two different approaches, either a received and transmitted power value, or a sum of bit rates allocated to all currently active bearers. This applies to both uplink and downlink load measurements. Details of measuring the air interface load can be found in the book “Radio Network Planning and Optimisation for UMTS”, edited by Jaana Laiho, Achim Wacker, Tomas Novosad, Wiley, New York, 2002, pages 178 and 179. Ascertaining the current load parameter value may involve initiating or performing an actual measurement of the cell load or receiving a measured value from another process, such as a dedicated measurement process performed for a Radio Network Monitoring Statistics unit.

According to one embodiment of the invention, in addition to the current cell load a current first target or limit value of at least one radio access bearer (RAB) parameter of said radio access bearer is ascertained. Any known RAB parameter works with the method of the invention. The nature of RAB parameters is generally that of a target value or a limit value. A typical example of a limit value is that of a maximum bit rate which is the maximum number of bits delivered within a timespan, divided by the duration of the timespan. A typical example of a target value is that of a target residual bit error ratio (BER). The present ascertaining step may comprise ascertaining a plurality of RAB target and/or limit parameter values. These values are provided in UMTS by Admission Control. Admission Control functions reside in a Serving GPRS Support Node (SGSN) server at the edge of a core network, and also locally in other core network elements, and in a Radio Network Controller (RNC).

The method of the invention provides a step of selecting a second target or limit value of said radio bearer parameter in dependence on said first target or limit value and said current value of said load parameter. That is, the RB parameter or parameters, respectively, are controlled by the present method. There is a range of possible values for each RB parameter. The actual RB parameter values are selected with the RAB parameters, the current cell load and the user specific load indication (e.g. pathloss) as input.

In the framework of the invention one or more RB parameter values are adapted to tune the RB to be established or maintained according to the given cell load and the RAB parameters. At low load, the RB parameters can be tuned to deliver higher service grades, even better than the negotiated RAB QoS parameters require. At high load, the RB parameters can be tuned to just fulfill the RAB QoS parameters for users with high pathloss. Users with low path-loss generally cause less interference, thus a high QoS can still be given to those users at a low cost in terms of average cell-load. If needed, RB parameters for all connections are tuned in order to make room for a new connection (instead of pre-emptioning of NRT connections).

Examples of RB parameters that may be tuned are: interleaving length, target frame erasure rate, and block error rate.

In a first preferred embodiment of the invention, selecting said target or limit value for said radio bearer parameter is performed in additional dependence of at least one parameter of said radio bearer belonging to a parameter group consisting of a service class requested for said radio bearer, a priority allocated to said mobile terminal, and a transmission power level used to establish or maintain said radio bearer. A service class is for example characterized by providing either real-time or non-real-time communication between said mobile terminal and said core-network node. Service classes providing a real-time or a non real-time communication, respectively, can be further divided into two or more service subclasses, characterized for example by a maximum allowable delay. In UMTS, there are currently four service classes, as will be described in further detail below.

In this embodiment, the controlling of QoS parameters provides the capability of allowing higher than required QoS in low load situations. For example, to deliver a data file to a low prioritized user utilizing a NRT service at low system load should be possible to achieve fast (without any re-transmissions) as long as he/she does not cause too high interference. When the system load is high, the power assigned to the same user for that same NRT service is lowered by the RAB-RB parameter mapping, yielding a higher delay and a longer transmission time.

Preferably said selecting step comprises evaluating a mapping function, said mapping function allocating to a given set of RAB parameter values at least one set of RB parameter values. A predefined mapping function allows fast tuning of a radio bearer according to predefined criteria.

However, there may be more than one set of RB parameters allocated to one specific set of RAB parameters. According to a further preferred embodiment of the invention, said selecting step comprises selecting a set of predefined default RB parameter values related to said first cell in case the radio bearer is to be established and more than one sets of RB parameter values are allocated to the current RAB parameter values. The default RB parameter values may be stored as system parameters. This embodiment has the drawback that an optimum RB configuration may not be selected when establishing the radio bearer. However, there is no delay caused in the evaluation of several RB parameter sets in order to find the optimum parameter set.

In a further preferred embodiment, however, the evaluating step comprises ascertaining all sets of RB parameters allocated to the given set of RAB parameter values. This provides a parameter fine tuning even at the start of a connection. This embodiment is, of course, also applicable at any later stage of maintaining a radio bearer.

In a further preferred embodiment of the invention the method can include a step of ascertaining at least one measured value of at least one radio bearer parameter of said established radio bearer. This radio bearer parameter is for example indicative of a signal-to-interference ratio of said radio bearer or an average bit rate transported through said radio bearer. After said measuring step a step of storing a measured performance parameter value and the pertaining RB parameter values is performed in a further embodiment in order to allow a statistical evaluation of the radio bearer parameters.

Based on this embodiment, a further preferred embodiment can include for the selecting step the substeps of

evaluating a cost function allocating to a given value of at said radio bearer parameter a cost value indicative of a cell capacity loss, and

selecting the RB parameter value for which the cost function has a minimum. In other words, using this approach, by comparing the costs obtained for the different RB parameter value options, the gain or loss in capacity can be estimated and the corresponding optimal target parameter value can be derived. This target parameter may for example be a block error rate target value used for the outer loop power control. This embodiment, like the invention in general, is valid both in the downlink as well as in the uplink. However, this embodiment is more relevant for the downlink situation.

Within this embodiment the configuration of a Radio Bearer (RB) is derived from the characteristics of the Radio Access Bearer (RAB) quality targets. This configuration includes for instance the BLER target for outer loop power control or the Radio Link Control (RLC) configuration. Several alternative solutions for an appropriate derivation of the Transport Channel (TrCH) quality target by means of a cost function can be used, when the Acknowledged Mode (AM) of an RLC protocol is employed in the communication. In the RLC AM, an Automatic Repeat reQuest (ARQ) mechanism is used for error correction.

With this embodiment, the best solution in terms of a quality target in view of the system capacity can be found from a Eb/NO to BLER mapping. In other words, using this approach, by comparing the costs obtained for the different cases the gain or loss in capacity can be estimated and the corresponding optimal target BLER can be derived.

In a further embodiment a step of replacing default RB parameter values with a statistical average of RB parameters optimizing the cost function may be performed.

According to one embodiment of the method of the present invention, the RAB parameter representing the first target or limit value can be at least one of the group of a maximum bit rate, a guaranteed bit rate, a residual Bit Error Ratio (BER), a transfer delay, a frame error rate, a maximum Service Data Unit (SDU) size, and a SDU error ratio. The RB parameter selected is at least one of the group of an interleaving length, a target frame erasure rate and a target block error rate, and the RLC configuration.

The method of the present invention is best performed repeatedly for each established each established radio bearer. A continuous monitoring and controlling of the RB parameters is preferred. This way a continuous adaptation to the changing load of the air interface is possible.

A further embodiment of the invention includes a step of handing the established radio bearer over from the first access network node to a second access network node of said radio access network. The second access network node takes over the role over the first access network node according to well known handover procedures. The second access-network node can be in the same cell or in a different cell of the radio access network.

The method of the invention is applicable for controlling radio bearer parameters in both uplink and downlink.

The method of the invention is also applicable when there is a switching from one radio bearer to another. In this case, an additional step of establishing a second radio bearer with RB parameters optimizing said cost function is performed, and a step of switching from said first radio bearer to said second radio bearer

According to a second aspect of the invention, a Radio Bearer (RB) Control unit for controlling at least on radio bearer parameter is provided, including

a Parameter Retrieval unit adapted to communicate with an external Admission Control unit for ascertaining a current first target or limit value of at least one Radio Access Bearer (RAB) parameter,

a Performance Data Retrieval unit adapted to communicate with an external Radio Network Monitoring Statistics unit for receiving at least one current measured value of at least one air interface load parameter,

a Radio Bearer Parameter Control unit communicating with said Parameter Retrieval unit and said Performance Data Retrieval unit, and adapted to select a second target or limit value of a Radio Bearer parameter in dependence on said first target or limit value and said current value of said air interface load parameter.

The RB control unit serves to implement the method of the invention. The advantages of the RB control unit of the invention therefore derive immediately from the advantages of the method of the invention described above. The RB control unit of the invention is in a preferred embodiment of the invention an integral part of an Admission Control unit. In another embodiment it is an integral part of a Radio Network Controller.

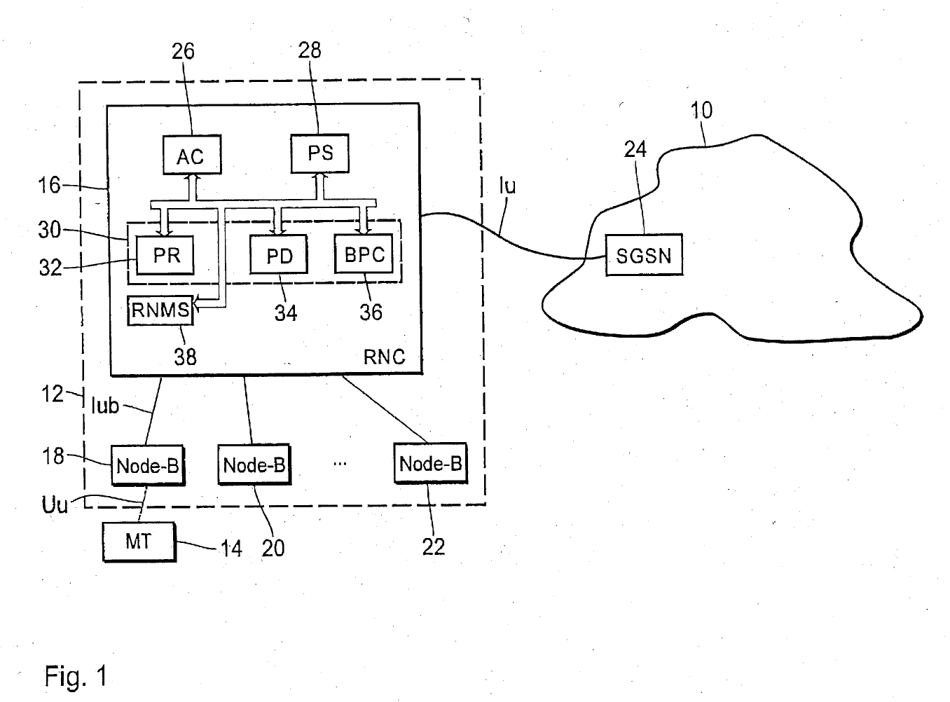

FIG. 1 shows a simplified network structure according to one embodiment of the invention. The network structure includes a core network 10, a Universal Terrestrial Radio Access Network (UTRAN) 12, and a mobile terminal (MT) 14 attached to the UTRAN 12. The MT communicates With the UTRAN via an Uu interface.

The structure of the UTRAN is not shown completely in FIG. 1. Details are included only where relevant for the present invention. However, it would be evident to a person of ordinary skill in the art that this description contains enough information to enable a person of skill in the art to make use the invention. The UTRAN has a Radio Network Controller (RNC) 16 communicating with a number of Node-B network nodes, three of which are shown with reference signs 18, 20, and 22. The RNC 16 further communicates with a Serving GPRS Support Node (SGSN) 24 in the core network.

The RNC 16 includes an Admission Control (AC) unit 26 and a Packet Scheduling (PS) unit 28. Further, a Radio Bearer Control unit 30 is provided. The Radio Bearer Control unit 30 has a Parameter Retrieval unit 32, a Performance Data Retrieval unit 34, and a Bearer Parameter Control unit 36. Further, a Radio Network Monitoring Statistics unit 38 is provided.

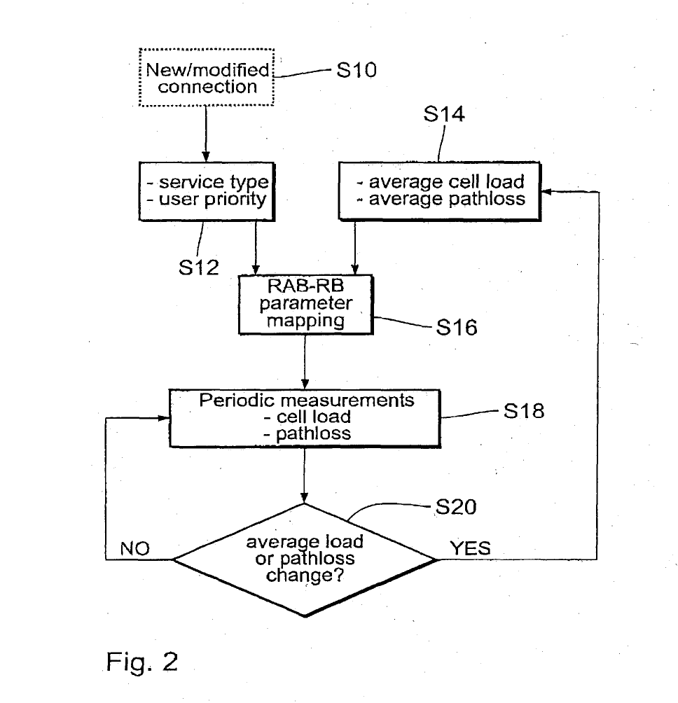

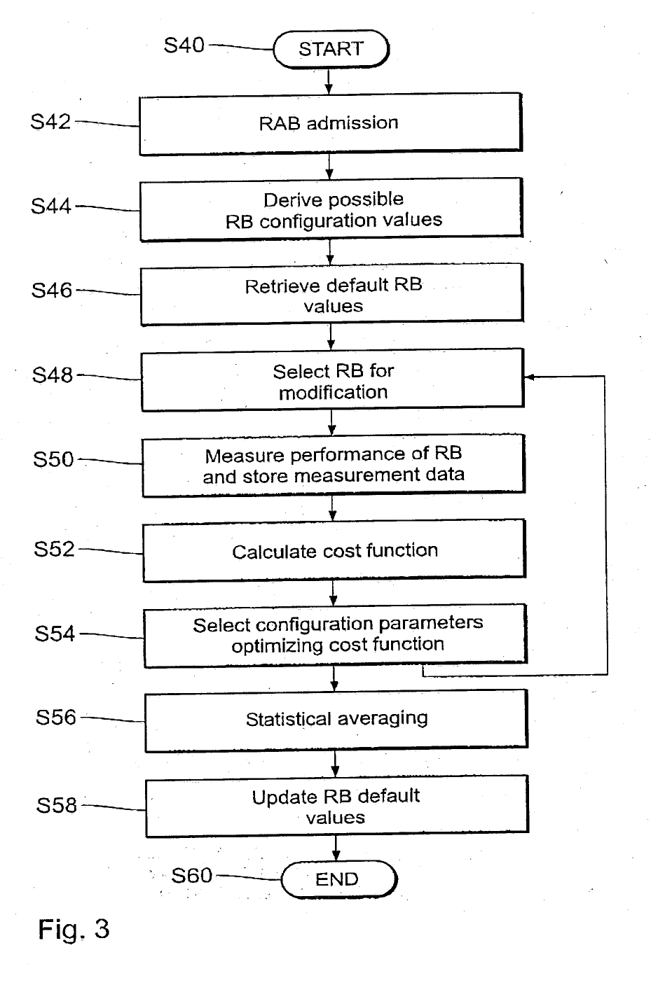

RNC 16 can be responsible for the control of the radio resources provided by the UTRAN 12. In the role of a controlling RNC of the Node-B nodes 18, 20, and 22 RNC 16 is responsible for load and congestion control of its radio cells. It executes Admission Control functions for new radio links to be established. This functionality is performed by Admission Control (AC) unit 26. AC unit 26 decides whether a new RAB is admitted or a current RAB can be modified. In this, AC unit 26 can receive input from RB control unit 30. For RT traffic AC 26 decides on the admission of a mobile terminal to the UTRAN 12. If the new radio bearer would cause excessive interference to the system, access is denied. For NRT traffic the optimum scheduling of the packets is determined after the RAB has been admitted. This can be done in cooperation with the Packet Scheduling (PS) unit 28. Packet Scheduling unit 28 handles all NRT traffic. It basically decides when a packet transmission is initiated, and the bit rate which is to be used. Further details of the functions provided by AC unit 26 and PS unit 28 will be described below with reference to FIGS. 2 and 3.

The Radio Bearer Control unit 30 cooperates with AC unit 26 and PS 28. RBC unit 30 performs a continuous monitoring and controlling of the RAB-RB parameter mapping for new and for already active connections. This mapping function can take into account service class, user priorities, current cell load, and the average interference caused by the mobile terminal.

Monitoring the current parameter settings can be performed by Parameter Retrieval (PR) unit 32. It accesses system tables for the default value used for a new RB and communicates with AC unit 26 to ascertain the current RAB and RB parameter settings for an established RB. Among the further parameters ascertained by PR unit 32 are the service class. The user priority Performance Data Retrieval (PDR) unit 34 communicate with Radio Network Monitoring Statistics (RNM$) unit 38 to obtain current interface load parameter values. Further, PD Retrieval unit 34 obtains the average pathloss for an established RB. As an option, statistical averages determined over a certain time span, such as an average of scheduled bit rates, can be obtained from RNMS unit 38. Statistical average values have the advantage that short periods of high load will not cause the control mechanism to lower the average throughput.

The Bearer Parameter Control unit performs the RAB-RB parameter mapping. It receives the ascertained parameter and performance data from PR unit 32 and PDR unit 34. The parameter mapping follows a preselected algorithm. This will be further elucidated in the context of the description of FIG. 3.

In an alternative embodiment (not shown), the functionality of PR unit 32 and PDR unit 34 can be integrated into BPC unit 36. This allows a simplification in that BPC unit 36 triggers parameter and performance data retrieval and directly receives that data from the AC unit 26 and the RNMS unit 28. This reduces the delay in processing the RB parameter control. The processing is further accelerated by integration of the BPC unit 38 of this alternative embodiment into AC unit 26.

The flow of the control mechanisms performed by BPC unit 36 in cooperation with PR unit 32 and PDR unit 34 will be explained in the following.

FIG. 2 shows a flow diagram for an embodiment of an RB control procedure to be performed by the BPC unit 36. In a step S10 a neW or a modified connection is detected. PR unit 32 then starts ascertaining the service type, i.e., the respective RT or NRT service class and the current RAB and RB parameter settings, and the user priority in a step S12. In a step S14, that in this embodiment is performed in parallel to step S12, the average cell load and the average path-loss are obtained from RNMS unit 38.

The data ascertained in parallel form the input to an RAB-RB parameter mapping step S16 performed by BPC unit 36. Details of one embodiment of the parameter mapping will be explained below.

In steps following S16, periodic measurements of the cell load and the pathloss are performed for the established RB, S18, and the measured values are monitored for changes in a step S20. If no change is observed, a next measurement is performed in the following measurement period. If a change is detected, the method branches back to step S14 in order to ascertain the new value of the average cell load and average path loss for a new cycle of the RAB-RB parameter mapping bit rate

FIG. 3 shows another embodiment of a RB control procedure to be performed by the RB control unit. This embodiment provides a way to optimize the RB configuration parameters with measurements of the associated values system performance, using cost functions. It provides an algorithm to control, e.g., the Transport Channel (TrCH) target BLER based on Quality requirements (QoS profile) of the different UMTS bearer services, and the impact of such a parameter on packet data capacity in a WCDMA system. As a result, the usage of such a BLER target can be more efficient. According to prior art, if the BLER is too low, capacity is wasted because retransmissions are not efficiently utilised to gain from additional time diversity. On the other side, if the BLER is too high, there are too many re-transmissions causing additional interference. The average delay is longer, the quality of the signalling is reduced, and more downlink orthogonal codes are consumed. Several solutions for an appropriate derivation of the TrCH quality target using a cost function will be described for situations where the RLC AM is employed in the communication.

After starting at step S40 and the detection of the admission of a RAB in a step S42, RB control unit 30 derives RB configuration values from the RAB parameters in a step S44. This can involve ascertaining first the RAB parameters with the aid of PR unit 32, as described for step S12 in the method of FIG. 2. Furthermore, default target values used for the new RB are retrieved in a step S46 by PR unit 32.

The configuration of a Radio Bearer (RB) is derived from the characteristics of the Radio Access Bearer (RAB) quality targets. This configuration includes for instance the BLER target for outer loop power control or the RLC configuration.

For some RB configuration elements there is not a unique solution to meet the RAB quality requirements. The chosen solution is derived from system parameters. In other words, within the whole available space of RB configuration parameter values, the RAB parameters will define a subset within which some RB parameters may vary, and the actual value chosen at RB setup is a system parameter. Different possible solutions will have different impacts on the system performance. The set of RB configuration parameters maximizing the system performance is dependent on the radio environment, e.g., multipath situation and speed.

A permanent selection mechanism determines RBs of which the configuration may be modified without deteriorating either the RAB performance or the system behavior (step S48). Performance measurements for the RB are performed and stored after convergence of slow mechanisms (step S50). From these performance measurements the values of a cost function are calculated in a step S52. Following the calculation of the cost function the target or limit RB parameter(s) optimizing the cost function are selected by BPC unit 36.

From that step, the method branches back to step to select a next RB for optimization. This way, a permanent monitoring and control of RB parameters is performed for all RB to be established or maintained. The method can be performed periodically so that each active RB configuration is controlled repeatedly after preset time intervals. It is, however, also possible to have several instances perform the method in parallel. This allows for a quasi-continuous or continuous monitoring and control of each active radio bearer.

Steps S56 and S58 provide a mechanism to update the RB default values to be selected at establishing the RB in step S46. In step S56 a statistical averaging of the RB target parameter values. RB parameter change from default can occur at initial RB setup or later on. In the latter case, the possible signalling load increase must be taken into account.

Several examples of cost functions that can be employed in step S52 will be presented below.

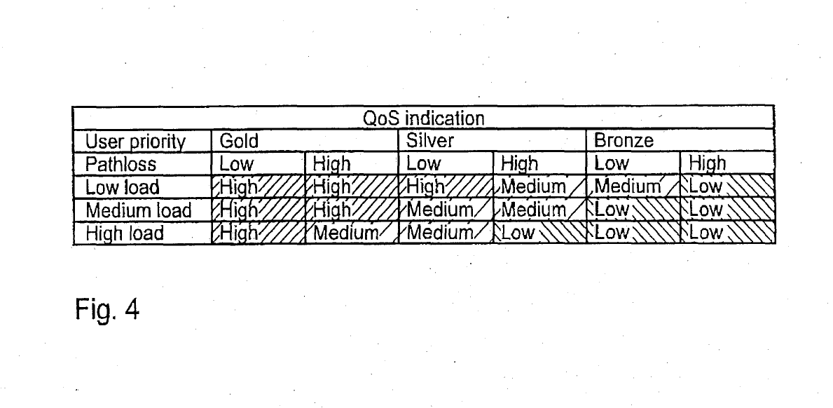

FIG. 4 gives an example of a QoS indicator table aiding the mapping between RAB and RB parameters in step S16 of FIG. 2. The table allocates a QoS indication in form of a RB parameter configuration with a predetermined link level performance to a given combination of user priority, pathloss of a radio bearer, and cell load.

The user priority can be defined in this example as “gold” for high priority, “silver” for medium priority, or “bronze” for low priority in the second to fourth column from the left. The pathloss is classified according to given pathloss parameter threshold values or intervals as either high or low in this example. In the fourth to sixth lines of the table the load is classified according to given load parameter threshold values or intervals as low, medium, or high. The hatched fields in the table of FIG. 4 show the QoS allocated to a particular configuration of user priority, pathloss, and cell load. For instance a high QoS level is delivered to a user with “gold” priority who has requested a radio bearer with high pathloss only in low and medium load situations (third column from the left). At high load this user will be delivered a medium QoS. The QoS parameter can for instance be a guaranteed bit rate, which is defined as the guaranteed number of bits delivered by the UMTS at a service access point (SAP) within a period of time, divided by the duration of the period. Other QoS parameters known in the art may be used to define the QoS level.

Obviously, more detailed differentiations could be used for a QoS indicator table. The present example serves only to convey the general principles of a QoS indicator table. Also, further classification parameters may be added, such as the requested service class, so that the table has three or more dimensions. This is easily done in electronic form. The mapping function realizes a simple and effective tool for an operator to differentiate the service grade to the users as a function of the system load. By controlling the mapping function the operator controls the quality that is delivered to the users in each service class, user priority etc. at different system loads.

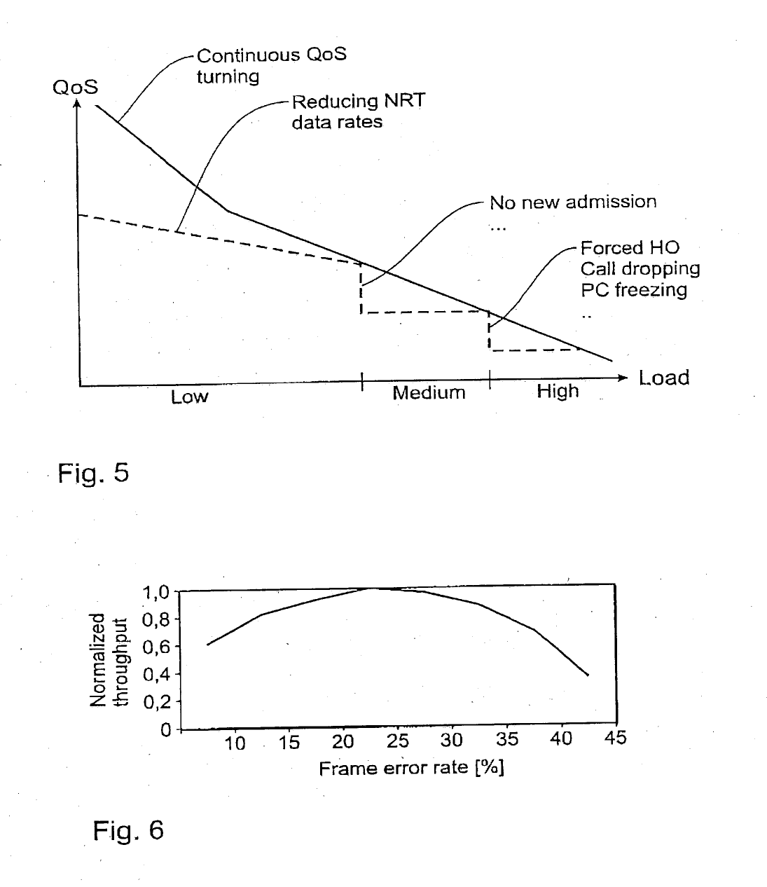

FIG. 5 shows in a diagram a schematic representation of the overall perceived QoS as a function of the cell load, in a comparison of the prior art and the method of the present invention. The load is differentiated again in three classes as low, medium or high along the abscissa of the diagram of FIG. 4. The QoS level increases along the ordinate. The dashed curve shows the QoS level according to the prior art. This curve exhibits step like QoS level changes at transitions between the load level classes. This is due to the fact, that according to the prior art, there is no automatic control of the QoS. With increasing load, certain services experience an at least partial break down. For instance, from the transition between low and medium load on, no new radio bearers will be admitted. This will occur independent of the user priority or service class requested by the respective user asking for admission. With the transition to a high cell load, handovers (HO) will be forced, some established calls will be dropped and some attached computers will experience freezing, i.e., a breakdown of their connection to the network.

In contrast to that, the continuous tuning of the QoS according to the above-discussed embodiment of the invention keeps the QoS level at a higher level for almost all cell load configurations. This provides improved QoS for all users at low system load and for users with low pathloss at high load, if the operators so allows for all user classes.

An example of the gain of using a continuous QoS tuning procedure is indicated in FIG. 6. Here the normalized throughput is shown as a function of frame error rate. The dependence shown is a schematic representation and not based on a measurement. However, it reflects the experience of the inventors. By increasing the frame error rate target from a 10% level to a 20% level the number of retransmissions and thereby the delay is increased for the user. However, the overall system throughput is increased at high loads.

That is, this embodiment of the invention makes it possible to improve the overall system throughput at high system load by lowering the QoS requirements for users with high path-loss, within limits set by RAB parameters and user priority classes, and facilitates a better than expected QoS-level for users in low loaded cells, and for users with a low path-loss in high loaded cells.

Some advantages of an improved system capacity at high loads, in terms of the overall system throughput, can be an improved QoS for all users at low system load and for users with low pathloss at high load (if the operators so allows for all user classes), and of providing a simple and effective tool for operators. An improved system capacity is provided at high system loads by using the optimal RB parameters, seen from a throughput perspective, for users that so allow. Note that the minimum required QoS-level in general only needs to be used for users with high pathloss, i.e., users who cause inter-cell interference in uplink and consume much transmission power in downlink.

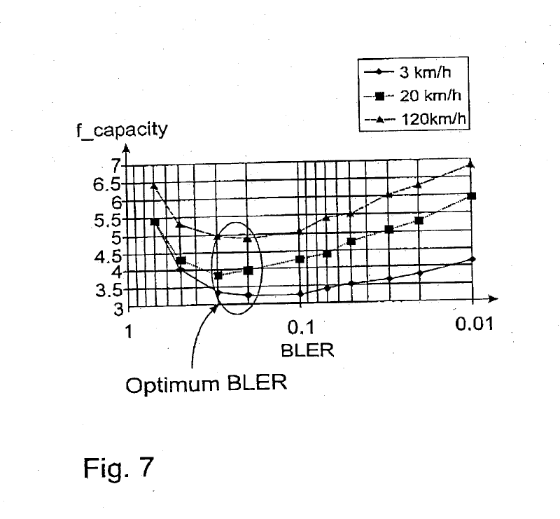

Several examples of cost functions will be illustrated. The first example will be explained with reference to FIG. 7.

The first example of a cost function is defined by (equation 1)

$${f}_{capacity} = \frac{{E}_{b} / {N}_{0}}{1 - BLER}$$

where the E_{b}/N₀ includes the retransmissions. ƒ_{capacity} describes the loss in capacity of the cell due to the RB at the given E_{b}/N₀ and given Block Error Rate (BLER).

For a given coding, interleaving and block size and for a given propagation channel, the optimal BLER target will be the one that maximizes the throughput, i.e. the number of information bits that per second are successfully transmitted in one cell, or the cell capacity. That is the optimal BLER target minimizes the cost function.

In practice, the received Eb/N₀ in the downlink channel (DCH) can be estimated from the measurements made at the Node-B and at the UE, and from the rate-matching attribute produced by AC for the multi-bearer service case: (e-

$$\begin{matrix}{( \frac{Eb}{No} )}_{DCH} = \frac{W}{R} \frac{{P}_{Tx\_RL}}{( \frac{{P}_{Tx\_CPICH}}{Ec / No} - α \cdot {P}_{Tx\_WBTS} )} \\ \frac{{RM}_{DCH} \cdot {N}_{DCH}^{C}}{{\sum }_{DCH ∈ RL} ( {RM}_{DCH} \cdot {N}_{DCH}^{C} )}\end{matrix} \qquad ( equation 2 )$$

In equation 2, W is the chip rate, R is the bit rate, P_{Tx}_{_{—}}_{RL} is a downlink transmitted code power reported by the Node B, P_{Tx}_{_{—}}_{CPICH} is the common pilot channel (CPICH) transmission power, P_{TX}_{_{—}}_{WBTS} is the total transmission power in the cell reported by the Node B, RM_{DCH} is the Rate Matching attribute for the DCH, N^{C}_{DCH} is the number of encoded bits of the DCH, and α is a scaling factor. Furthermore a linear system can be written to resolve 1/E_{b}/N₀ and the term 1-BLER if needed. The drawback of using this formula is the E_{b}/N₀ accuracy, which is quite poor (±3 dB), and the availability of the measurement report from the terminal including this value.

In the capacity formula of equation 1 the BLER target derived by AC is used. In the uplink both the BLER and E_{b}/N₀ measurements are generally available.

FIG. 7 shows in a semilogarithmic diagram values of the cost function ƒ_{capacity} of equation 1 as a function of the BLER. The BLER is shown on a logarithmic scale while the cost function values are plotted on a linear scale. Three curves are shown for three different velocities of the mobile terminal, 3 km/h, 20 km/h, and 120 km/h. As a general trend for all values of the BLER, the higher the speed, the higher the capacity loss, i.e., the higher the value of the cost function. All three curves exhibit a minimum for a BLER in the range between 0.2 and 0.3, which is indicated by an ellipse surrounding this range. This range therefore has the optimum target BLER value with respect to an optimization of the cost function of equation 1. That means, after evaluation of the cost function in step S52 of FIG. 3, the BLER target will be selected in step S54 by RBC unit 36 in the range between 0.2 and 0.3.

An improved approach for estimating the cell capacity may be based on the following second example of a cost function (equation 3):

$${f}_{capacity} = \frac{1}{W} \frac{Eb / No}{1 - BLER} \frac{I}{{L}_{p}}$$

Here, W is the chip rate, BLER is the BLER target, Lₚ is the path gain and I is the interference power including noise, i.e., I=PN+Pown+Pother.

This cost function can be used as a spectral efficiency indicator.

A simplified approach for estimating the cell capacity may be based on the following third example of a cost function (equation 4):

$${f}_{capacity} = \frac{RLpower / DCHuserBitRate}{1 - BLER}$$

where RLpower is the downlink transmitted code power reported by the Node-B, BLER is the BLER target, and the DCHuserBit rate is the transport channel bit rate.

The BLER target maximizing the cell capacity can be determined based on downlink code power measurements and bit rate measurements, that is, the maximum transport format set (Max TFS) bit rate or active session throughput for that particular communication.

Using this theory, the best solution (with respect to the system capacity) in terms of quality target can be found from the E_{b}/N₀ to BLER mapping alone. In other words, using this approach, by comparing the costs obtained for the different cases the gain or loss in capacity can be estimated and the corresponding optimal target BLER can be derived. This embodiment provides a mechanism that is automatic and adaptive to the cell radio environment, and thus maximizes the network performance by means of a cost function.

Not all RBs may be modified at the same time, or without degrading performance. For instance, a low BLER target cannot be requested from remote mobiles, or the load must be high enough to represent a realistic situation, but probing must not be allowed in high load situations.

The cost function optimization may be used at two levels: first, at the RB level, convergence of slow mechanisms, e.g., an outer loop power control mechanism, needs to be achieved before the collection of performance measurements. If reconfiguration is allowed in this case, a local optimum can be found for the RB and be used after a while. Second, at cell level, statistics of the cost function can be used to change the default setup parameter for the cell. The optimum value is different for each cell. After HO, the cost function gain must be balanced against the signaling load increase.

The invention may be implemented as a separate-(optional) RRM feature, interacting with Admission Control to retrieve the RAB and RB information and modify them, and with Radio Network Monitoring Statistics to retrieve the Performance Measurements. This invention may be used in RAN and network management system products. The invention is described for a 3GPP RAN, in particular UTRAN, but may be applied to other RANs, including possibly GERAN and IP-RAN.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for controlling at least one radio bearer parameter of a first radio bearer to be established or maintained between a mobile terminal and a first access-network node in a first cell of a cellular radio access network, said method comprising:
determining a current value of at least one load parameter indicative of an air interface load of the first cell;
determining a current first target or limit value of at least one radio access bearer parameter of a radio access bearer; and
selecting a second target value or a limit value of the radio bearer parameter based upon the first target or limit value and the current value of the load parameter,
wherein the first access-network node communicates with a core-network node in a core network to establish or maintain at least one radio access bearer between the mobile terminal and the core-network node.

2. The method as recited in claim 1, wherein determining the current value of the load parameter comprises measuring the current value.

3. The method as recited in claim 1, wherein selecting the target or limit value for the radio bearer parameter is performed based upon at least one parameter of the radio bearer belonging to a parameter group, the parameter group including at least one of a service class requested for the radio bearer, a priority allocated to the mobile terminal, and a transmission power level used to establish or maintain the radio bearer.

4. The method as recited in claim 3, wherein the service class of the parameter group provides real-time or non-real time communication between the mobile terminal and the core-network node.

5. The method as recited in claim 4, wherein the service class is further divided into two or more service subclasses, based upon a maximum allowable delay.

6. The method as recited in claim 1, wherein selecting the second target value or limit value comprises evaluating a mapping function, with the mapping function allocating at least one set of radio bearer parameter values to a given set of radio access bearer parameter values.

7. The method of claim 6, wherein the selecting step comprises selecting a set of predefined default radio bearer parameter values related to the first cell when the radio bearer is to be established, and a plurality of sets of radio bearer parameter values being allocated to the current radio access bearer parameter values.

8. The method as recited in claim 7, wherein evaluating the mapping function comprises determining all sets of radio bearer parameters allocated to the radio access bearer parameter values.

9. The method as recited in claim 1, further comprising determining at least one measured value of at least one radio bearer parameter of the established radio bearer.

10. The method of claim 9, wherein said at least one radio bearer parameter is indicative of a signal-to-interference ratio of said radio bearer.

11. The method of claim 9, wherein said at least one radio bearer parameter is indicative of an average bit rate transported through said radio bearer and scheduled by a Packet Scheduler.

12. The method of claim 9, comprising a step of storing a measured performance parameter value and the pertaining radio bearer parameter values.

13. The method of claim 9, wherein said selecting step comprises:
evaluating a cost function allocating to a given value of said radio bearer parameter a cost value indicative of a cell capacity loss; and
selecting the radio bearer parameter value for which the cost function has a minimum.

14. The method of claim 13, further comprising
establishing a second radio bearer with radio bearer parameters optimizing said cost function; and
switching from said first radio bearer to said second radio bearer.

15. The method of claim 7, comprising replacing said default radio bearer parameter values with a statistical average of radio bearer parameters optimizing the cost function.

16. The method of claim 1, wherein determining the current first target of limit value of at least one radio access bearer parameter comprises determining a value of at least one of the group of a maximum bit rate, a guaranteed bit rate, a residual Bit Error Ratio (BER), a transfer delay, a frame error rate, a maximum Service Data Unit (SDU) size, and a SDU error ratio.

17. The method of claim 1, wherein said radio bearer parameter is at least one of the group of an interleaving length, a target frame erasure rate and a target block error rate, and a radio link control configuration.

18. The method of claim 1, further comprising repeating the steps for each established radio bearer.

19. The method of claim 1, further comprising a step of handing over said established radio bearer from said access network node to a second access network node in a second cell of said radio access network, wherein said second cell takes over a role of said first cell, and wherein said second access network node takes over a role of said first access network node.

20. The method of claim 1, wherein said radio bearer provides downlink services.

21. The method of claim 1, wherein said radio bearer provides at least one of uplink services and downlink services.

22. A Radio Bearer Control unit for controlling at least one radio bearer parameter, said unit comprising:
a Parameter Retrieval unit configured to communicate with an external admission control unit for ascertaining a current first target or limit value of at least one radio access bearer parameter;
a Performance Data Retrieval unit adapted to communicate with an external radio network monitoring statistics unit for receiving at least one current measured value of at least one air interface load parameter; and
a Radio Bearer Parameter Control unit communicating with said parameter retrieval unit and said performance data retrieval unit, and configured to select a second target or limit value of a radio bearer parameter based upon the first target or limit value and said current value of said at lest one air interface load parameter.

23. An admission control unit, comprising a Radio Bearer Control unit according to claim 22.

24. A radio network controller, comprising a Radio Bearer Control unit according to claim 22.

25. A system for controlling at least one radio bearer parameter of a first radio bearer to be established or maintained between a mobile terminal and a first access-network node in a first cell of a cellular radio access network, said system comprising:
first determining means for determining a current value of at least one load parameter indicative of an air interface load of a first cell;
second determining means for determining a current first target or limit value of at least one radio access bearer parameter of a radio access bearer; and
selecting means for selecting a second target value or limit value of the radio bearer parameter based upon the first target or limit value and the current value of the load parameter,
wherein the first access-network node communicates with a core-network node in a core network to establish or maintain the at least one radio access bearer between the mobile terminal and the core-network node.

26. A radio bearer control unit for controlling at least one radio bearer parameter, said radio bearer control unit comprising:
parameter retrieval means for communicating with an external admission control unit for ascertaining a current first target or limit value of at least one radio access bearer parameter;
performance data retrieval means for communicating with an external radio network monitoring statistics unit for receiving at least one current measured value of at least one air interface load parameter; and
radio bearer parameter control means communicating with said parameter retrieval means and said performance data retrieval means, for selecting a second target or limit value of a radio bearer parameter based upon the first target or limit value and the current value of the at least one air interface load parameter.
